(19) United States
(12) Patent Application Publication
(10) Pub. No.: US 2018/0124525 A1
(43) Pub. Date: May 3, 2018

(54) METHOD AND SYSTEM FOR RECOGNIZING A BEAT WITH A HEARING AID

(71) Applicant: SIVANTOS PTE. LTD., SINGAPORE (SG)

(72) Inventors: MATTHIAS MUELLER-WEHLAU, NUERNBERG (DE); ULRICH GIESE, FUERTH (DE)

(21) Appl. No.: 15/802,708

(22) Filed: Nov. 3, 2017

(30) Foreign Application Priority Data
Nov. 3, 2016 (DE) 10 2016 221 578.7

(51) Int. Cl. H04R 25/00; G06F 17/30; G06F 3/01; G06F 3/16

(52) U.S. Cl. CPC H04R 25/502; H04R 25/55; G06F 3/165; G06F 17/30764; G06F 3/011; G06F 17/30743

(57) ABSTRACT

A method for recognizing a beat for a hearing system includes converting an acoustic input signal into an electrical input signal in an input transducer. The electrical input signal is processed into an electrical output signal in a signal processing unit. The electrical output signal is converted into an output signal in an output transducer. A beat is recognized by analyzing the electrical input signal and the recognized beat is perceivably output to a hearing system user. A corresponding hearing system for recognizing a beat in the input signal and outputting the recognized beat in a perceivable manner is also provided.

### CROSS-REFERENCE TO RELATED APPLICATION

This application claims the benefit, under 35 U.S.C. § 119, of German Patent Application DE 10 2016 221 578.7, filed Nov. 3, 2016; the prior application is herewith incorporated by reference in its entirety.

### BACKGROUND OF THE INVENTION

### Field of the Invention

A hearing aid serves to supply acoustic environmental signals to a person with impaired hearing. The acoustic environmental signals are processed correspondingly for compensating the respective hearing impairment and, in particular, are amplified. To that end, a hearing aid usually includes an input transducer, for example in the form of a microphone, a signal processing unit with an amplifier, and an output transducer. As a rule, the output transducer is realized as a miniaturized loudspeaker and is also referred to as a receiver. In particular, it produces acoustic output signals which are guided to the ear of the patient and produce the desired hearing perception in the latter.

Different constructions of hearing aids are offered in order to accommodate numerous individual requirements. In the case of so-called ITE (in-the-ear) hearing aids, a casing which contains all functional components, including the microphone and the receiver, is worn, at least in part, in the auditory canal. CIC (completely-in-canal) hearing aids are similar to the ITE hearing aids, but they are worn completely in the auditory canal. In the case of BTE (behind-the-ear) hearing aids, a casing with components such as a battery and the signal processing unit is worn behind the ear. Depending on the configuration, the receiver may be worn directly in the auditory canal of the wearer (so-called receiver-in-the-canal (RIC) hearing aids). Alternatively, the receiver is disposed within the casing itself and a flexible sound tube, which is also referred to as a tube, guides the acoustic output signals of the receiver from the casing to the auditory canal (tube hearing aids).

In order to obtain the desired audible perception independently of the hearing aid type, the sound signals required for verbal understanding must be made perceivable and distinguishable for the person with impaired hearing and, ideally, be approximated to a natural sound perception. To that end, use is made of e.g. hearing aids with compression and interference noise suppression, as a result of which the speech understanding is optimized, the loudness perception is normalized, interference noises are suppressed and the comfort or audible perception of very loud and very quiet input signals is also improved.

However, despite the algorithms described above, an interference-free or undisturbed hearing perception cannot be implemented for a hearing aid wearer in all situations. By way of example, problems with recognizing the beat of music that is playing may arise for a musician or dancer who wears a hearing aid. That can be traced back to the fact that the signal components that carry the beat information items are covered or obscured by the very quickly operating algorithms that are used for signal processing of acoustic input signals, in particular a noise suppression or dynamic compression, and a beat as such is no longer perceivable, or only perceivable with difficulties, by the hearing aid wearer. Incorrect entries or making music or dancing “without rhythm” may be the consequence.

German Publication DE 10 2007 043 081 A1, corresponding to U.S. Publication US 2009/0067650, has disclosed a method and a configuration for capturing the type of external sound sources by using a hearing aid. Within the scope of the method, at least one identification signal is output by an external sound source. The identification signal is captured by the hearing aid and evaluated in the hearing aid for the purposes of recognizing the type of sound source. In accordance with German Publication DE 10 2007 043 081 A1, corresponding to U.S. Publication US 2009/0067650, the type of sound source can be recognized from the pulse frequency and the pulse width of the identification signal.

U.S. Publication US 2016/0292270 A1 discloses a method, through the use of which pieces of music are analyzed in terms of their tempo (beats per minute) on the basis of an acoustic analysis. The tempo of the respective piece of music is compared or correlated to the current heart rate of a user and a piece of music that fits to the heart rate of the user is selected in the case of deviations between the tempo of the piece of music and the heart rate.

U.S. Pat. No. 8,213,640 B2 has disclosed a method in which a music device predetermines sounds or signals for a musician who is wearing a hearing aid, in which sound from the surroundings is captured and compared with the prescription, and in which the corresponding comparison result is output. The method is particularly suitable for tuning musical instruments. In one variant, the music device is a metronome which predetermines a beat.

### SUMMARY OF THE INVENTION

It is accordingly an object of the invention to provide a method and a system for recognizing a beat with a hearing aid, which overcome the hereinafore-mentioned disadvantages of the heretofore-known methods and systems of this general type.

A first object underlying the invention is that of specifying a method which allows a hearing system user to perceive a beat in an improved manner.

A second object underlying the invention is that of specifying a hearing system, through the use of which a correspondingly improved perception of a beat can be implemented.

With the first object in view there is provided, in accordance with the invention, a method for recognizing a beat for a hearing system, wherein an acoustic input signal is converted into an electrical input signal in an input transducer, the electrical input signal is processed into an electrical output signal in a signal processing unit, the electrical output signal is converted into an output signal in an output transducer, a beat is recognized by analyzing the electrical input signal, and the recognized beat is perceivably or perceptibly output to a hearing system user.

The beat is identified by an appropriate analysis of the electrical input signal and processed in such a way that it can be output in a perceivable manner. This ensures that the beat information items are not lost or obscured during the subsequent signal processing. The analysis of an acoustic signal with respect to a beat is known per se and not a subject of the present invention. By way of example, the beat of an acoustic signal is recognized in many electronic playback devices and output visually. In this case, the beat recognition contains e.g. statistical methods and observes the time profile of the sound energy and/or it evaluates e.g. the time correlation of the sound energy in characteristic frequency bands.

In order to ensure that the beat is reliably recognized within the scope of the analysis of the electrical input signal, the latter is preferably analyzed in non-processed form. In particular, the acoustic input signal is analyzed in non-compressed form. In another alternative, the input signal is pre-processed in order, for example, to reduce it to a used signal with, subsequently, the used signal being analyzed with respect to a beat contained therein.

The hearing system is, in particular, a hearing aid, with, preferably, the signal processing unit contained in the latter being used for analyzing the electrical input signal. However, the invention is not restricted to a hearing aid. Rather, the invention is implementable in any device which has a capacity for signal processing of acoustic signals. Within this meaning, a hearing system is e.g. a smartphone, a television set, a computer, in particular a tablet PC, a headphone system, e.g. with noise suppression, etc. In a further alternative, the conversion of the acoustic input signal into an electrical input signal and/or the analysis of the electrical input signal is carried out in an external device, e.g. in a smartphone or tablet PC, wherein the perceivable, in particular audible, output of the recognized beat or beat signal is effectuated by way of a hearing aid. The introduction of both the electrical input signal and a recognized beat or beat signal into the hearing system or into the hearing aid may be effectuated in a wired manner, wirelessly by way of radio or directly. In this respect, the input transducer may be a microphone, a reception antenna or a connection or output port of an external audio device.

In an advantageous configuration of the invention, the beat is output in an acoustically perceivable manner by using the hearing system itself. To this end, recognized beat components in the output signal are preferably output in an amplified manner. Amplifying the recognized beat components is effectuated, particularly preferably, in the signal processing unit within the scope of the remaining algorithms for processing the input signal into the output signal. By outputting the amplified beat components in the output signal, the hearing system user is allowed to directly and easily capture the beat in the output signal, in particular in the acoustic output signal.

In the present case, a beat is understood to mean, in principle, a sequence of periodically repeating individual beats which, in music, coincide with a group of certain notes within a specific period of time. In this respect, the beat of the invention relates to the beat of a musical piece just as much as to a periodically repeating arbitrary acoustic signal, e.g. the heartbeat of a human or a beat prescription by a metronome. In particular, there is a different emphasis on the individual beats for a specific beat.

In a preferred variant, a heartbeat is recognized as a beat in the input signal and the recognized heartbeat is output in a perceptible manner. In a preferred variant, the recognized heartbeat is output with amplification as a beat component in the output signal. A medical practitioner or a caregiver with damaged hearing who wishes to monitor the heartbeat of a patient, for example by way of a stethoscope, can thus clearly perceive the heartbeat of the patient in the output signal that is output by the hearing system and, for example, recognize irregularities in the cardiac rhythm. Alternatively, the heartbeat can also be visualized, for example on a smartphone that is carried along or on a different appropriate output device. In another, likewise preferred variant, e.g. a heartbeat that is acoustically reproduced by way of a medical monitoring device is captured by the hearing system and appropriately processed or prepared and output for the hearing system user. A further application lies in the sports sector. In this case, e.g. the user's own heartbeat can be reproduced preferably acoustically within the scope of the invention. In an expedient configuration, the beat is captured on the basis of an acoustic input signal. It is alternatively preferred if the beat is provided by conventional pulse measurement methods. In this case, the use for the user lies in acoustic monitoring of his/her own cardiovascular function.

In a further advantageous configuration of the invention, a beat signal that is synchronous with the recognized beat is output. In particular, the synchronous beat signal is produced synthetically by using the recognized beat or derived from the latter. In this case, the type of output can be brought in line with various situations that are appropriate for the respective conditions. Thus, a visual output is just as preferred as an acoustic output. More preferably, the perceivable output for the hearing device wearer is effectuated haptically or by way of a vibration signal.

In a further preferred variant, the beat signal that is synchronous with the beat is output by using a mobile communication device. By way of example, the amplified beat signal is acoustically output by way of a smartphone or tablet PC as a perceivable signal with a suitable intensity, form and/or frequency or the amplified beat signal is visualized for the hearing aid wearer on the display of the respective communication device.

In another, likewise preferred variant, the beat signal that is synchronous with the beat is output as a speech signal. By way of example, the speech output of the beat signal is effectuated by a voice output in the ear of the hearing system user. By way of example, in the case of a musician, the beat of the music can be output in a perceivable manner to the hearing aid wearer by counting in a beat (e.g. 4/4 time: “one, two, three, four, one, two, three, four . . . ”). In the case of a caregiver who is monitoring the heartbeat, the heartbeats per minute can, for example, be output acoustically for that caregiver.

It is further advantageous if a tactile clock is used for outputting the beat signal that is synchronous to the beat. A clock emits pulses at a specific frequency. Thus, for example, a musician can carry along such a clock against their body, with the clock perceivably specifying the beat to the hearing system user by way of vibrations.

Advantageously, deviations from a predetermined beat of the beat that is recognized within the scope of analyzing the input signal are recognized automatically. By way of example, if a musician who plays in an orchestra and wears a hearing aid deviates from the tempo of the orchestra in terms of the way that they play their musical instrument, then this deviation is recognized automatically. Expediently, the musician is informed in this respect and can accordingly bring his or her playing into line with the predetermined tempo. In view of the heartbeat of a patient, the deviation of the measured heartbeat from a predetermined, uniform heartbeat is identified. In this way, it is possible, for example, to recognize cardiac arrhythmias and introduce appropriate measures for treatment.

Recognizing various beats is preferably ensured by virtue of the input signal being subjected to a frequency decomposition or to frequency filtering. As a result, beats occurring in different frequency ranges are distinguished and individualized. Each individually recognized beat is expediently output individually and in a perceivable manner, as described in general in the present case.

With the second object of the invention in view, there is also provided a hearing system comprising an input transducer for converting an acoustic input signal into an electrical input signal, a signal processing unit, connected to the input transducer, for processing the electrical input signal, an output transducer, connected to the signal processing unit, for converting the processed electrical output signal into an output signal, and a beat analysis unit which is configured and embodied to recognize a beat in the electrical input signal and perceivably output the recognized beat to a hearing system user.

In this case, the advantages described for the method for recognizing a beat and the advantageous developments thereof may be transferred analogously to the hearing system.

In a preferred development of the hearing system, the beat analysis unit is implemented in the signal processing unit. In an alternative variant, the analysis is carried out in an external apparatus, in particular in a smartphone, in a tablet PC or in any other device which has the capacity for processing an acoustic input signal or an electrical input signal derived therefrom.

In the present case, a hearing system is understood to mean a hearing device per se, and also headphones, a headset or a loudspeaker. Within this meaning, a hearing system is e.g. a smartphone, a television set, a computer, in particular a tablet PC, a headphone system, e.g. with noise suppression, etc. In a further alternative, the conversion of the acoustic input signal into an electrical input signal and/or the analysis of the electrical input signal is carried out in an external device, e.g. in a smartphone or tablet PC, wherein the perceivable, in particular audible, output of the recognized beat or beat signal is effectuated by way of a hearing aid. The introduction of both the electrical input signal and a recognized beat or beat signal into the hearing system or into the hearing aid may be effectuated in a wired manner, wirelessly by way of radio or directly. In this respect, the input transducer may be a microphone, a reception antenna or a connection or output port of an external audio device.

Expediently, the signal processing unit is configured and embodied in such a way that beat components in the output signal can be output in an amplified manner. As a result of outputting the amplified beat components in the output signal, the latter is output as a combined audio signal. Hence, the hearing aid wearer perceivably hears the amplified beat components in their audible audio signal.

Preferably, the beat analysis unit is configured and embodied to output a beat signal that is synchronous with the beat. The output is preferably effectuated by using a mobile communication device such as a smartphone, a computer or a tablet PC. In this case, e.g. a visual output by way of a screen or a speech output by way of a loudspeaker is possible. Expediently, the beat signal that is synchronous with the beat is transmitted from the beat analysis unit to the external device by using a radio connection.

In an alternatively preferred manner, a tactile clock is used to output the beat signal that is synchronous with the beat. By way of example, a vibration element that can be worn on the body serves as a clock, the vibration element outputting the recognized beat in a manner that is perceivable by a hearing aid wearer.

Further advantageous configurations for the hearing system emerge from the dependent claims that are directed to the method.

Other features which are considered as characteristic for the invention are set forth in the appended claims.

Although the invention is illustrated and described herein as embodied in a method and a system for recognizing a beat with a hearing aid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a flow diagram showing a procedure for recognizing a beat for a hearing aid; and

FIG. 2 is a longitudinal-sectional view of a hearing aid with a signal processing unit for recognizing a beat and for outputting the latter in a perceivable manner.

### DETAILED DESCRIPTION OF THE INVENTION

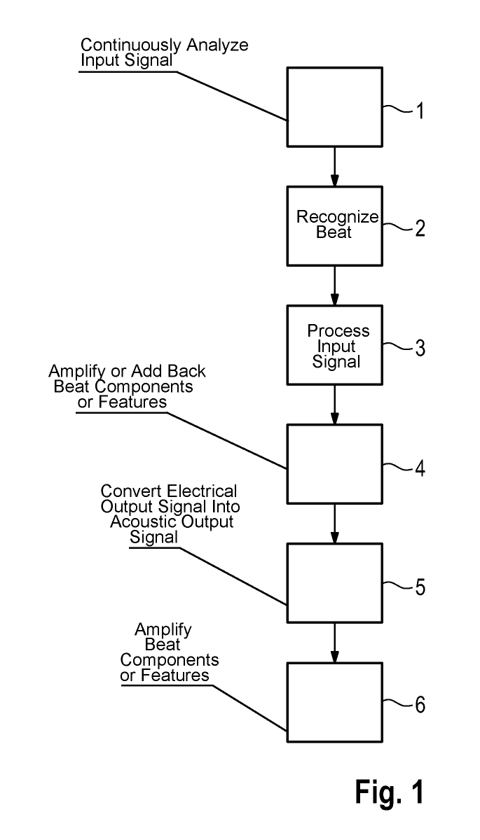

Referring now to the figures of the drawings in detail and first, particularly, to FIG. 1 thereof, there is seen an illustration of a procedure for recognizing a beat for a hearing aid. In order to recognize and e.g. amplify the beat in an acoustic input signal, the electrical input signal converted from an acoustic input signal by using e.g. a microphone is analyzed continuously (step 1). A beat is recognized within the scope of the analysis on the basis of beat features such as e.g. periodically returning sound peaks (“beats”) (step 2). In particular, beat components or beat features contained in the signal are recognized in this case.

The electrical input signal is typically processed in a signal processing unit and prepared for the hearing aid wearer in a frequency specific manner and in accordance with recognized hearing situations (step 3). In particular, there is e.g. a frequency compression of the signal, a noise suppression and/or a feedback compensation within the scope of this signal processing (step 3). The beat is analyzed before this signal processing.

The beat components or beat features recognized in the electrical input signal are, in the present case, e.g. amplified within the scope of the signal processing or added back to the processed signal after carrying out the aforementioned processing algorithms (step 4). Finally, the electrical output signal obtained in this manner is converted into an acoustic output signal (step 5). The beat components or beat features of the acoustic input signal are contained in the output signal or reproduced in a manner that is being perceivably or perceptibly amplified for the hearing aid wearer (step 6).

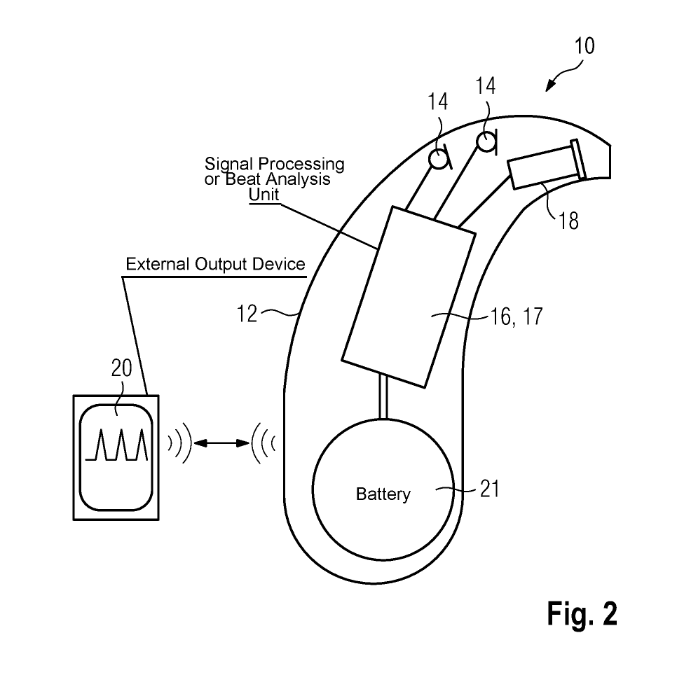

FIG. 2 shows a behind-the-ear hearing aid (BTE hearing aid) as a hearing aid 10. The hearing aid 10 includes a hearing aid casing 12, in which two microphones 14 are disposed as input transducers 14. The microphones 14 are used to record the sound from the surroundings as an acoustic input signal and to convert that acoustic input signal into an electrical input signal. The non-processed electrical input signal is analyzed continuously for recognizing the beat.

The electrical input signal is processed or amplified within a signal processing unit 16. The signal processing unit 16 is likewise used as a beat analysis unit 17 which identifies a beat or beat components in the signal that has still not been processed. The processed output signal is then converted into an acoustic output signal in an output transducer 18, e.g. a loudspeaker. In one variant, the recognized beat components are added to the output signal in an amplified manner. In another variant, the recognized beat is output for the hearing aid wearer as a speech signal through the output transducer 18. In a further variant, the recognized beat is guided to an external output device 20, e.g. a smartphone, through radio for example, with the external output device outputting the beat in a visual or tactile manner (e.g. by way of vibrations).

The hearing aid 10 and, in particular, the signal processing unit 18, are supplied with power by a battery 21 that is likewise integrated into the hearing aid casing 12.

1. A method for recognizing a beat for a hearing system, the method comprising the following steps:
converting an acoustic input signal into an electrical input signal in an input transducer;
processing the electrical input signal into an electrical output signal in a signal processing unit;
converting the electrical output signal into an output signal in an output transducer;
recognizing a beat by analyzing the electrical input signal; and
perceivably outputting the recognized beat to a hearing system user.

2. The method according to claim 1, which further comprises carrying out the step of analyzing the electrical input signal in non-processed form.

3. The method according to claim 1, which further comprises outputting recognized beat components in an amplified manner in the output signal.

4. The method according to claim 1, which further comprises:
recognizing a heartbeat as a beat; and
outputting the recognized heartbeat in a perceivable manner.

5. The method according to claim 4, which further comprises carrying out the step of outputting the recognized heartbeat in a perceivable manner as an amplified beat component in the output signal.

6. The method according to claim 1, which further comprises outputting a beat signal being synchronous with the recognized beat.

7. The method according to claim 6, which further comprises using a mobile communication device to output the beat signal being synchronous with the recognized beat.

8. The method according to claim 6, which further comprises outputting the beat signal being synchronous with the recognized beat as a speech signal.

9. The method according to claim 6, which further comprises using a tactile clock to output the beat signal being synchronous with the recognized beat.

10. The method according to claim 1, which further comprises automatically recognizing deviations of the recognized beat from a predetermined beat.

11. A hearing system, comprising:
an input transducer for converting an acoustic input signal into an electrical input signal;
a signal processing unit connected to said input transducer for processing the electrical input signal;
an output transducer connected to said signal processing unit for converting the processed electrical output signal into an output signal; and
a beat analysis unit configured and constructed to recognize a beat in the electrical input signal and to perceivably output the recognized beat to a hearing system user.

12. The hearing system according to claim 11, wherein said beat analysis unit is implemented in said signal processing unit.

13. The hearing system according to claim 11, wherein said beat analysis unit is configured and constructed for outputting recognized beat components in the output signal in an amplified manner.

14. The hearing system according to claim 11, wherein said beat analysis unit is configured and constructed to output a beat signal being synchronous with the recognized beat.

15. The hearing system according to claim 14, which further comprises a tactile clock for outputting the beat signal being synchronous with the recognized beat.
